(19) United States
(12) Patent Application Publication
(10) Pub. No.: US 2007/0127564 A1
(43) Pub. Date: Jun. 7, 2007

(54) Image display device for car monitoring system

(76) Inventor: Shih-Hsiung Li, Taipei (TW)

Correspondence Address: COOPER & DUNHAM, LLP, 1185 AVENUE OF THE AMERICAS, NEW YORK, NY, 10036, US

(21) Appl. No.: 11/294,275

(22) Filed: Dec. 5, 2005

(51) Int. Cl. H04N 7/18; H04N 11/04

(52) U.S. Cl. 375/240.01; 348/148

(57) ABSTRACT

An image display device for a car monitoring system includes a microprocessor, digital image decoder/encoder, a timing controller, and a display. The microprocessor connects to a reversing sensor to acquire a distance value of a detected obstacle. The digital image decoder connects to a camera to convert an analog image signal into a digital format. The timing controller is respectively connected to the microprocessor and the digital image decoder to generate a combined image signal with an appropriate compression ratio. The digital image encoder is connected between the timing controller and a display to convert the combined image signal of the digital format into an analog format and then outputting to the display. The screen of the display is divided into several parts including a monitored image play area, an obstacle data display area and a dynamic obstacle distance display area.

### BACKGROUND OF THE INVENTION

1. Field of the Invention

The invention relates in general to an image display device for a car monitoring system, and more particularly to an image display device for a car monitoring system that can synchronously capture multiple monitored information such as an image and a distance value of an obstacle detected by a reversing sensor and then displays the information on a display without mutual interference of the captured data.

2. Description of the Related Art

With reference to FIG. 5, a reversing sensor 80 installed at a rear of a car is very popular nowadays. The reversing sensor 80 can detect if there is an obstacle by using an ultrasonic wave to calculate a distance to the obstacle, which is very helpful for a driver to get clear information when backing a car. Moreover, a camera 90 configured at the rear of the car is also widely used to take images around the rear of the car and then display the images on a display 91 in front of the driver. Hence the driver can easily see the situation behind the car. However, the conventional display 91 usually displays the image captured by the camera 90 in a full screen with the calculated distance value shown on the screen. The distance value occupies a part of the image pixels in the screen and also causes a noise to the images. Hence the conventional display 91 can be further improved.

### SUMMARY OF THE INVENTION

The present invention provides an image display device for a car monitoring system having a user-friendly image interface for a driver to receive and understand instantaneous information regarding a detected obstacle. A screen of a display is divided into several parts to show images and data separately, and the image is also displayed in a form of an animation to display movement of the vehicle. Hence the driver can easily see the instantaneous distance to the obstacle without interference.

In order to achieve the above-mentioned objectives, the image display device for a car monitoring system of the present invention includes a microprocessor, digital image decoder/encoder, a timing controller, and a display. The microprocessor includes an input terminal connected to a reversing sensor for a vehicle to acquire a distance value of a detected obstacle. The digital image decoder includes an input terminal connected to a camera to convert an analog image signal into a digital format. The timing controller is respectively connected to the microprocessor and the digital image decoder to generate a combined image signal with an appropriate compression ratio. The digital image encoder is configured between the timing controller and a display for converting the combined image signal of the digital format into an analog format and then outputting the signal to the display. The screen of the display includes a monitored image display area, an obstacle data display area and a dynamic obstacle distance display area.

### BRIEF DESCRIPTION OF THE DRAWINGS

FIG. 1 shows a system block diagram of the present invention.

FIG. 2 shows a complete detailed circuit diagram of the present invention.

FIGS. 2A-2M are circuit diagrams derived by dividing FIG. 2.

FIG. 3 shows a first example of a screen generated on a display of the present invention.

FIG. 4 shows a second example of a screen generated on a display of the present invention.

FIG. 5 shows an auxiliary installation diagram of a conventional car.

### DETAILED DESCRIPTION OF THE INVENTION

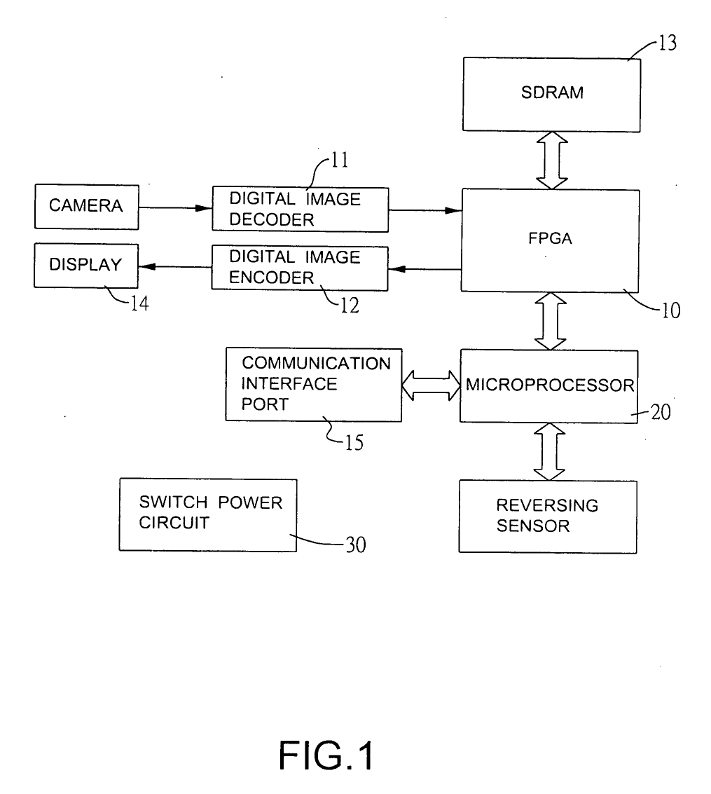

With reference to FIG. 1, an input terminal of a timing controller 10 is connected to a digital image decoder 11. An input terminal of the digital image decoder 11 can be connected to a camera (not shown in the diagram), so as to convert an analog image signal outputted by the camera into a particular data flow and then sends the signal to the timing controller for processing. In this preferred embodiment of the present invention, the analog image signal is converted into a data flow that meets a CCIR601 standard format.

In this preferred embodiment, the timing controller 10 is a Field Programmable Gate Array (FPGA). The timing controller 10 is further connected to an SDRAM (Synchronous Dynamic Random Access Memory) 13 and a microprocessor 20. The input terminal of the timing controller 10 is also connected to a digital image encoder 12. The SDRAM is used as a buffer for accessing the outputted data flow of the digital image decoder 12. An output terminal of the digital image encoder 12 is connected to a display 14 for the timing controller 10 to send out image data that converts a specific standard format of a digital image data flow to an analog format image signal. The analog image signal is then sent to the display 14 to be displayed.

The microprocessor 20 has a built-in specific compression ratio table to allocate the timing controller 10 of the FPGA. The microprocessor 20 can also initialize the digital image encoder/decoder 12/11. Moreover, the microprocessor 20 is connected to a reversing radar by an input terminal to read a distance value of a detected obstacle. In addition, the microprocessor 20 is further connected to a communication interface port 15 to connect to a computer. A power supply circuit 30 provides power at different voltages to supply the power for each of the aforesaid components in the present invention.

The compression ratio table of the microprocessor 20 is further introduced as follows.

In order to compose an image, a common image requires scaling. Since the scaled image is not exactly integral times of the original image, some image pixels are removed based on a video frequency property and an eyesight feature. In order to remove these image pixels regularly, locations of the predetermined image pixels that will be removed are taken down and a non-linear image data table is obtained. Then the table data is recorded to a memory of the microprocessor 10. Thereby the table data is the so-called “compression ratio table”.

The pre-stored compression ratio table is automatically sent to the timing controller 10 of the FPGA after startup. With this method, the usage quantity of the FPGA can be greatly reduced, to facilitate implementation of customers' requests for dynamic changes.

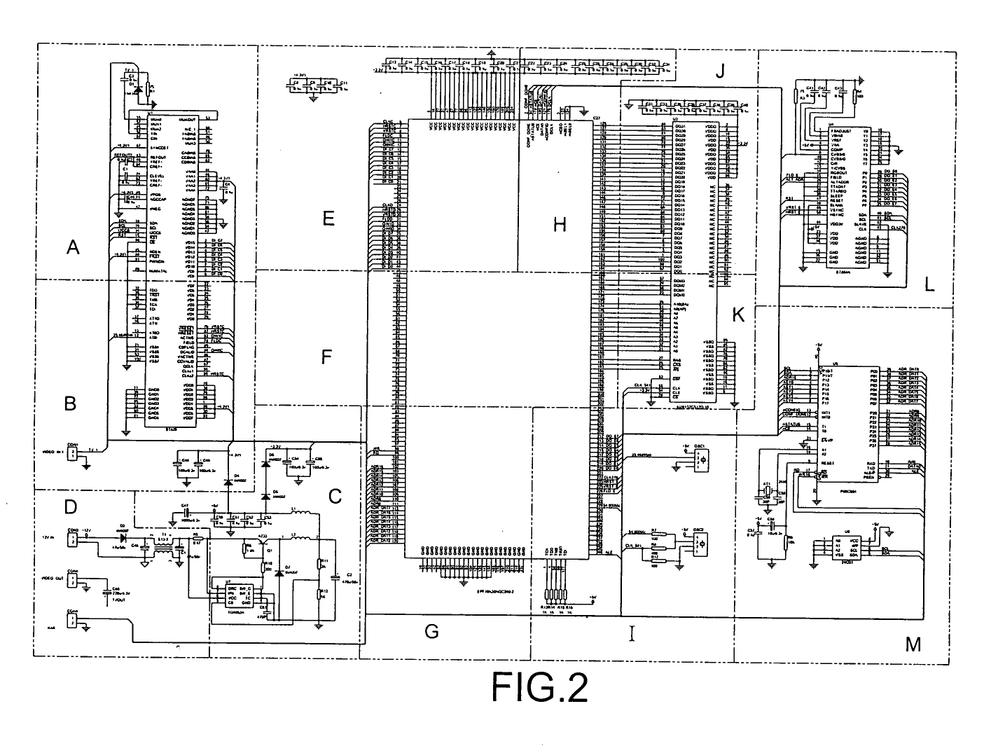

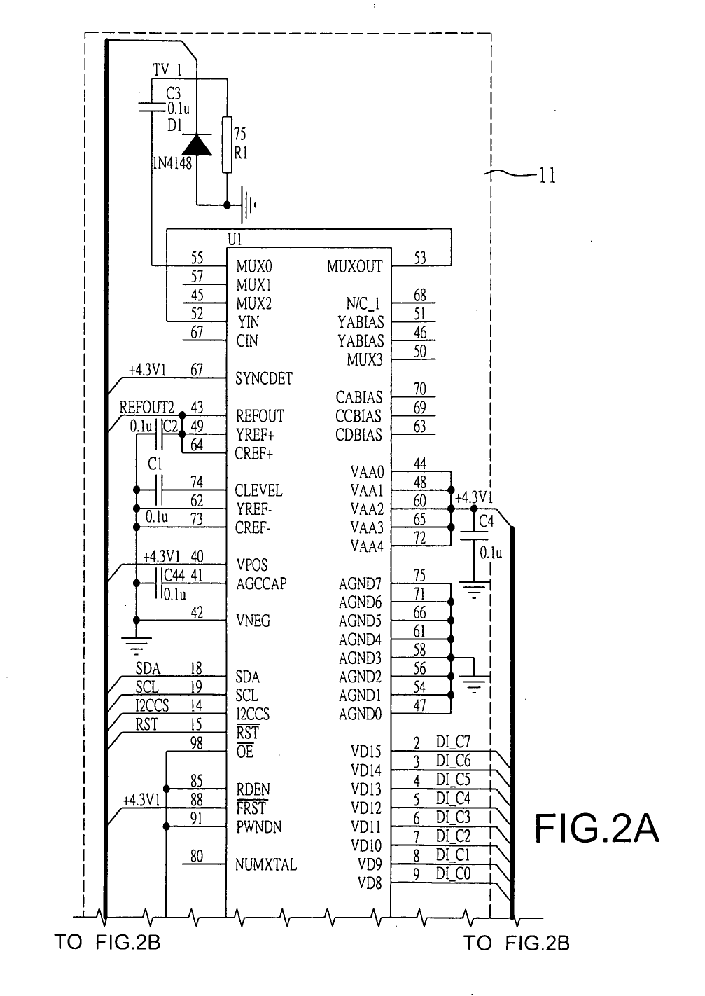

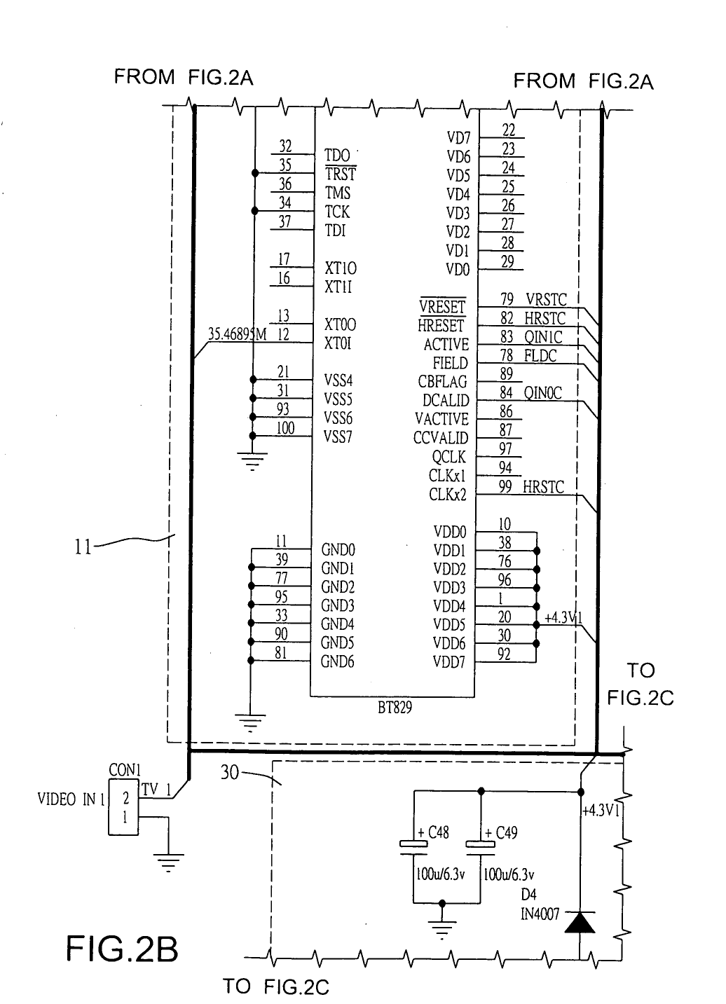

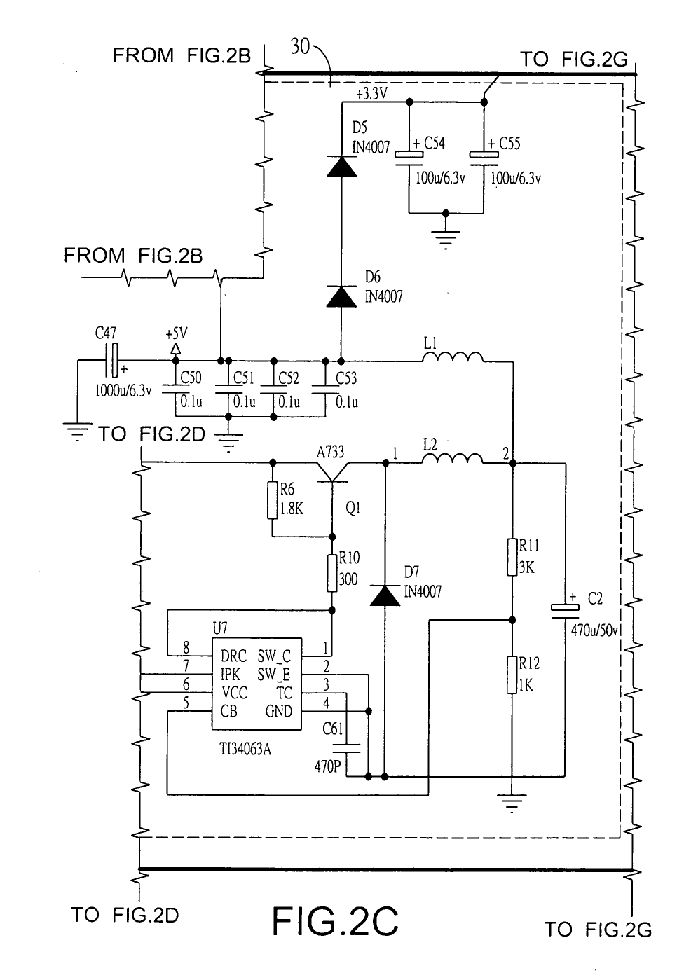

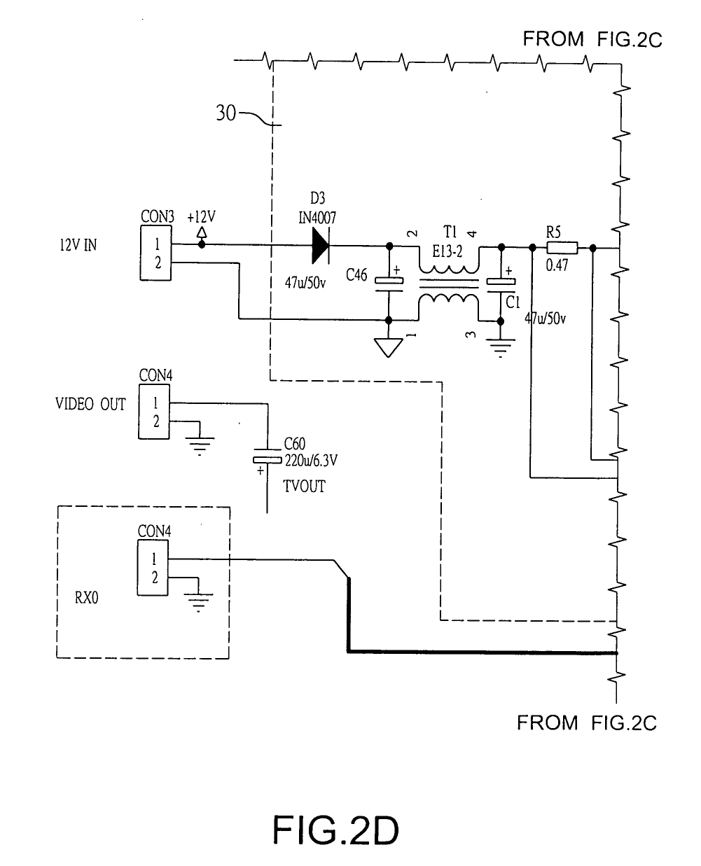

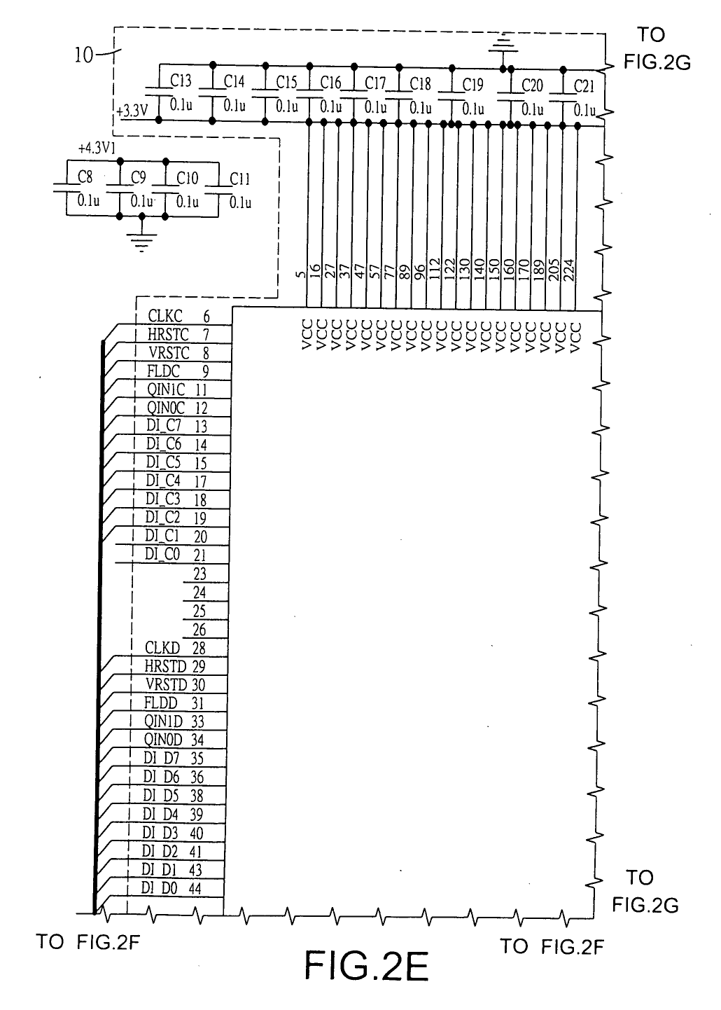

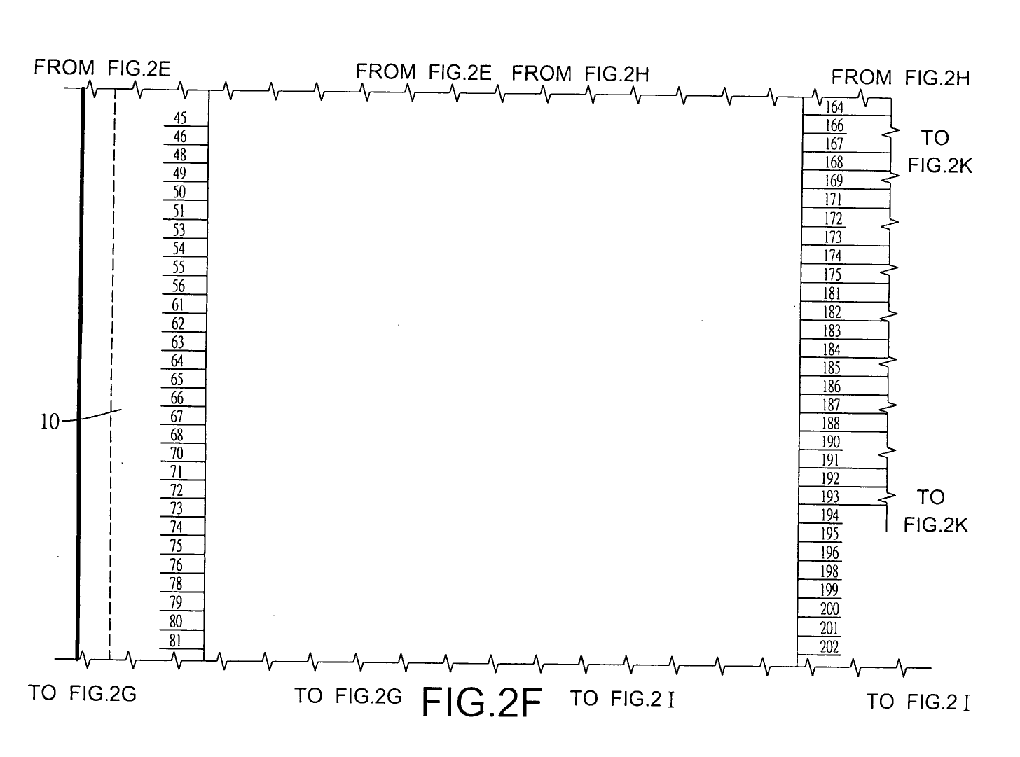

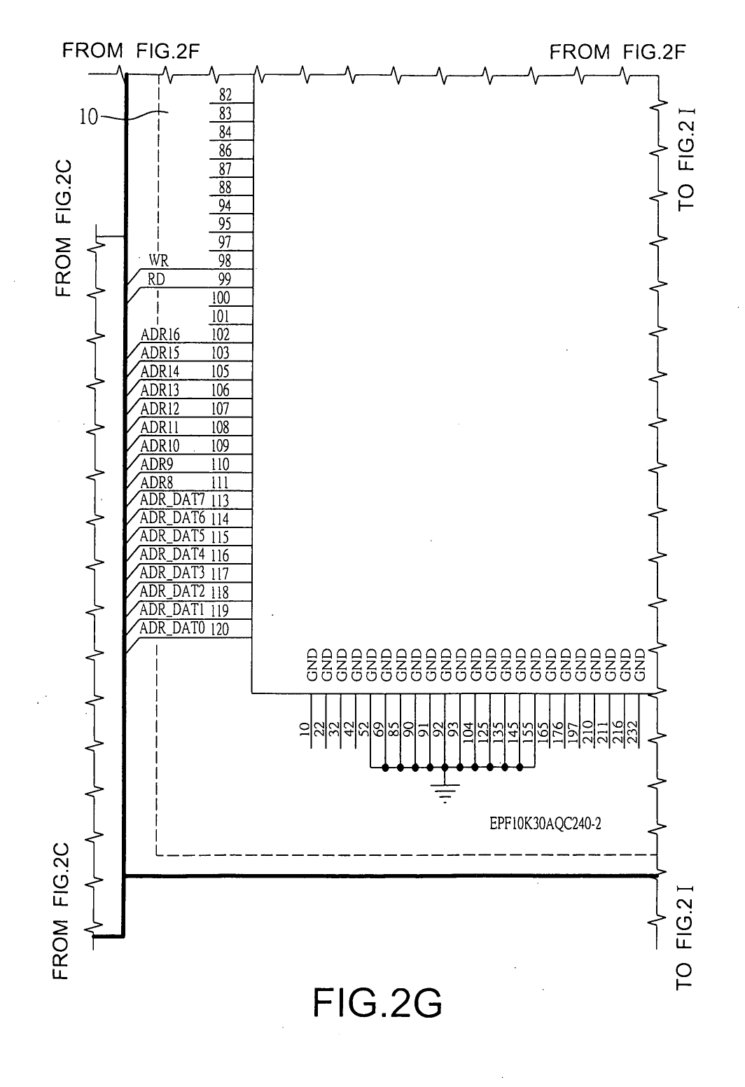

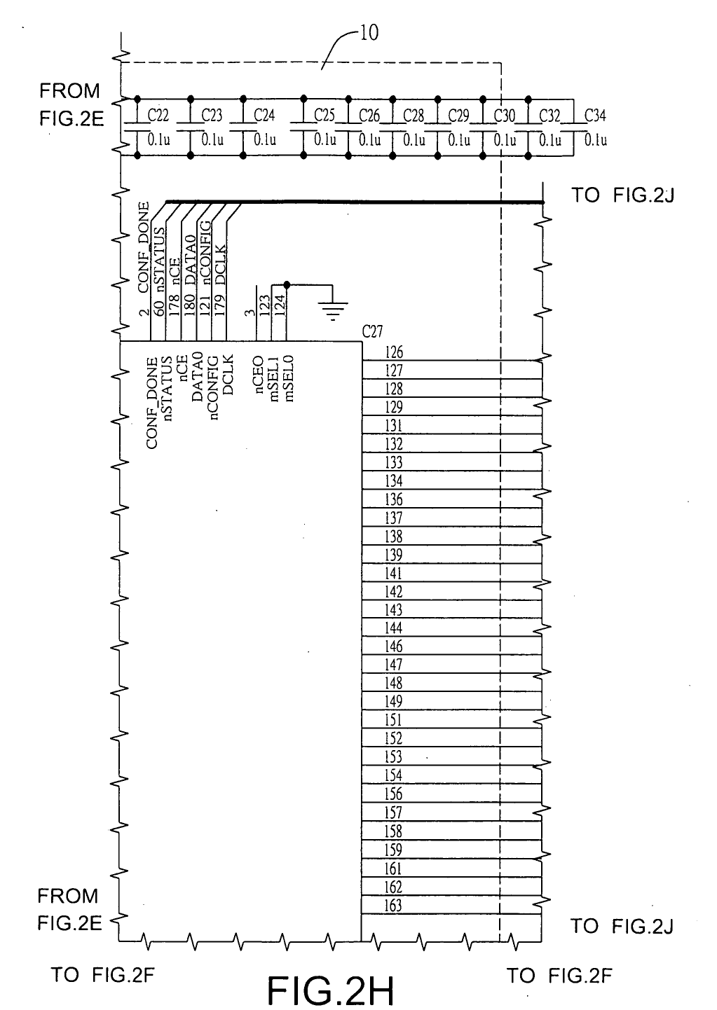

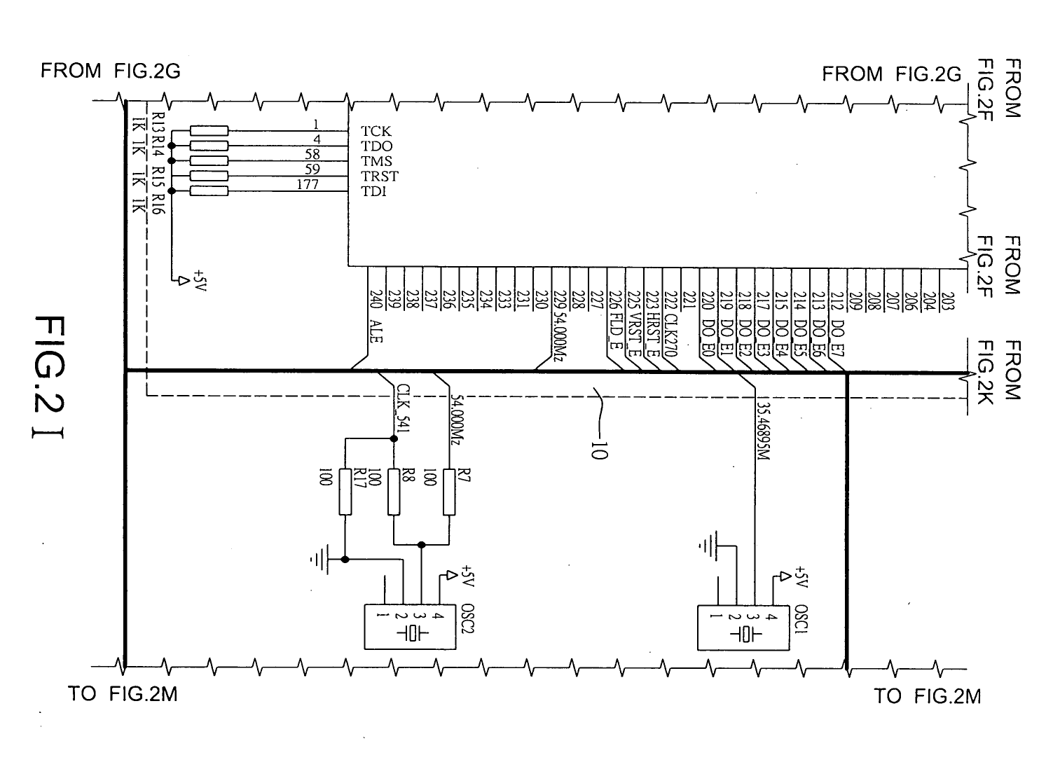

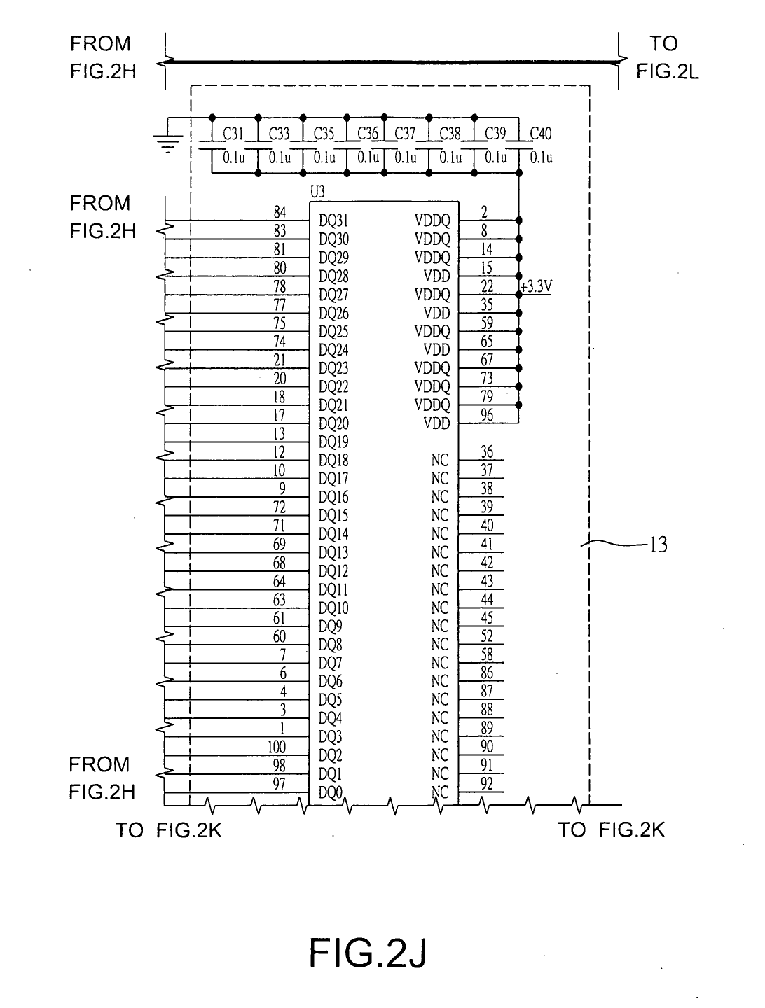

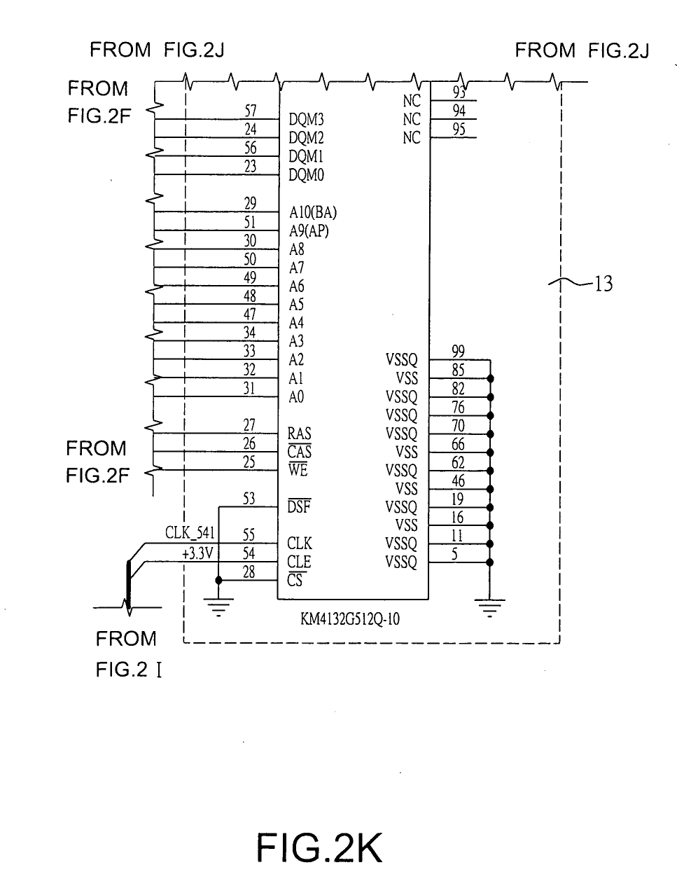

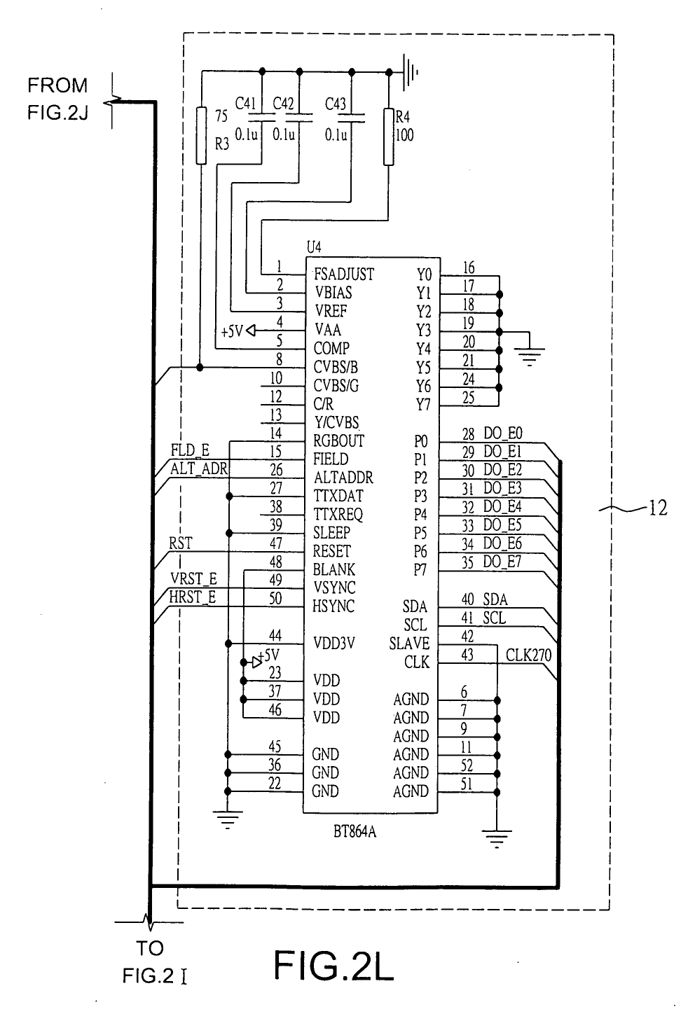

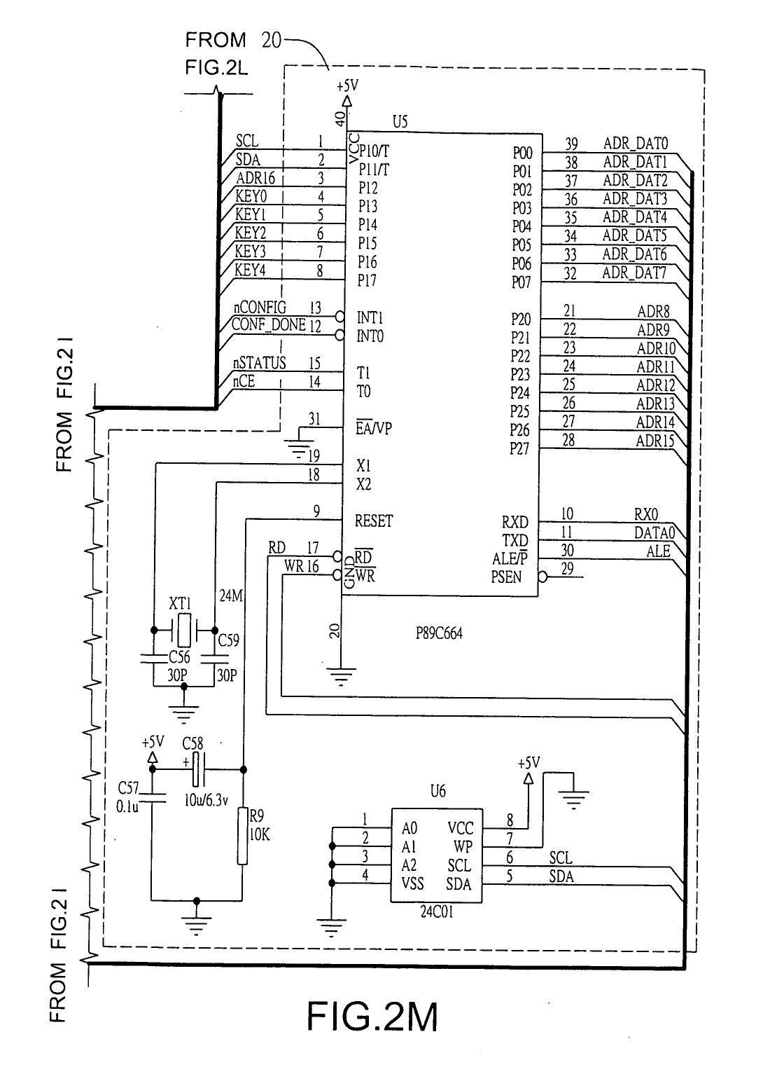

With reference to FIG. 2, a detailed circuit diagram of the present invention is illustrated as follows.

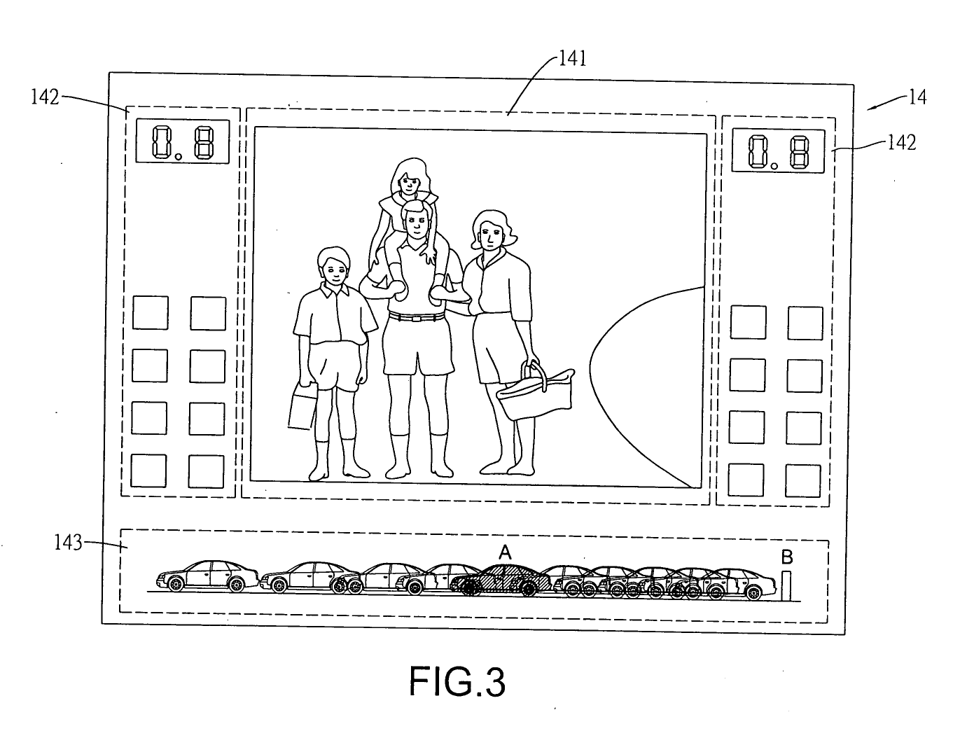

The timing controller further recovers a certain row of the image pixels as data flow of a CCIR 601 standard format in accordance to the outputted compression ratio table, and then outputs the data flow to the digital image encoder 12. The digital image encoder 12 recovers the data flow to the analog image signal and outputs the signal to the display 14 to be displayed. A first example of a practicable screen shown in the display 14 is illustrated in FIG. 3. The screen is divided into several parts including a monitored image play area 141, an obstacle data display area 142 and a dynamic obstacle distance display area 143.

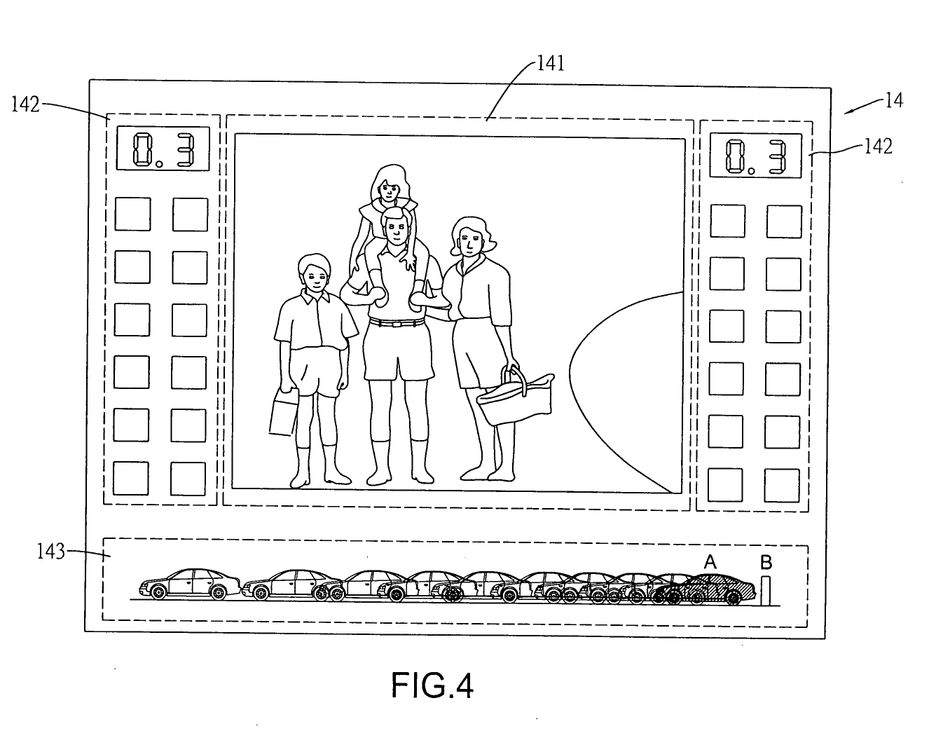

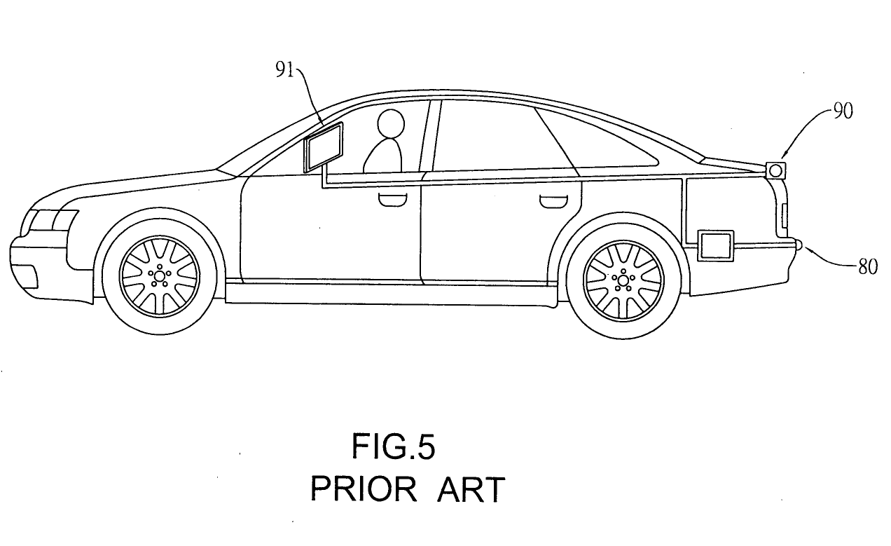

The monitored image play area 141 is used to play dynamic images that are captured by the camera. The obstacle data display area 142 is located at both sides of the screen in this example of the preferred embodiment whereas both sides are independent to show values which indicate the distance to the obstacle. The obstacle data display area 142 uses different color blocks to identify the distance from the obstacle, such as green, yellow or red. The dynamic obstacle distance display area 143 is located at a bottom of the screen with one end showing an obstacle A and a simulated car body pattern B in front of the obstacle A. The aforesaid picture indicates the distance between the car and the obstacle A. Along with a backing movement of the car, the car body pattern B gradually approaches the obstacle A as shown in FIG. 4. In this way, an user-friendly interface together with the digitalized distance value shown on the obstacle data display area 142 are provided to a driver, so that the user can easily know the distance to the obstacle A.

It is clear from the aforesaid description that each of the parts of the screen can independently display the image and the value without a mutual interference issue. A particular point is that the dynamic obstacle distance display area 143 shows an animation of the movement of car, which provides the user-friendly image interface to assist the driver to understand the instantaneous distance to the obstacle.

In conclusion, the present invention combines a timing controller, a microprocessor and a digital encoder/decoder to operate in coordination with a reversing sensor and a camera. The aforesaid auxiliary installation on a car provides useful information, which is clearly displayed to the driver, so that the driver can conveniently understand the instantaneous distance to an obstacle. The information is well planned and displayed on the screen, so as to eliminate the mutual interference issue. Moreover, the user-friendly image interface shows a dynamic animation, which enhances the functionality of the display. Therefore the present invention is more advanced than the conventional technique. While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image display device for a car monitoring system comprising:
a microprocessor having an input terminal connected to a reversing sensor of a vehicle to acquire a distance value of a detected obstacle;
a digital image decoder having an input terminal connected to a camera to convert an analog image signal that is outputted by the camera into a digital format;
a timing controller respectively connected to the microprocessor and the digital image decoder to generate a combined image signal with an appropriate compression ratio;
a digital image encoder configured between the timing controller and a display to convert the combined image signal of the digital format into an analog format and then outputting the signal to the display to be displayed; wherein
a screen of the display is divided into a plurality of parts comprising an monitored image display area, an obstacle data display area and a dynamic obstacle distance display area; wherein the dynamic obstacle distance display area shows an animation of a movement of a car.

2. The image display device for a car monitoring system as claimed in claim 1, wherein the timing controller is made up by a Field Programmable Gate Array (FPGA).

3. The image display device for a car monitoring system as claimed in claim 1, wherein the timing controller is connected to an SDRAM (Synchronous Dynamic Random Access Memory), wherein the SDRAM is used as a buffer for accessing outputted data flow from the digital image decoder.

4. The image display device for a car monitoring system as claimed in claim 1, wherein the microprocessor is further connected to a communication interface port to connect to a computer.
